(19) United States
(12) Patent Application Publication
(10) Pub. No.: US 2025/0133149 A1
(43) Pub. Date: Apr. 24, 2025

(54) ROUTER MANAGEMENT

(71) Applicant: Charter Communications Operating, LLC, St.Louis, MO (US)

(72) Inventors: Nereus Osric Edwin Lobo, Denver, CO (US); Scott Myles Dotto, Denver, CO (US)

(21) Appl. No.: 18/383,465

(22) Filed: Oct. 24, 2023

(51) Int. Cl. H04L 67/75

(52) U.S. Cl. CPC H04L 69/08; H04L 41/0803

(57) ABSTRACT

Send, from an accessibility gateway microservice, to a device of a user, a message including a menu of access point management options; obtain, at the accessibility gateway microservice, from the device of the user, a message including a selection from the menu; at the accessibility gateway microservice, translate the selection from the menu into a command formatted for a connectivity platform services layer; and dispatch, from the accessibility gateway microservice, to the connectivity platform services layer, the command.

### FIELD OF THE INVENTION

The present invention relates generally to the electrical, electronic and computer arts, and, more particularly, to management of routers in broadband networks and the like.

### BACKGROUND OF THE INVENTION

A router forwards data packets between computer networks; for example, based on information in its routing table. Typical Internet Protocol (IP) routers for home and small office applications forward IP packets between on-premises computers and the Internet. Enterprise routers typically connect large business or Internet Services Provider (ISP) networks to the Internet backbone. For visually impaired customers, managing a router may be a challenging task.

Text messages are electronic messages, typically including alphanumeric characters, sent between two or more computing devices such as mobile phones, desktop and/or laptop computers, or other computers, using, for example, a cellular network, satellite, Internet connection, or similar network. Text messages can be sent using the Short Message Service (SMS), Multimedia Messaging Service (MMS), instant messenger applications, and the like.

Interactive voice response (IVR) allows telephonic interaction with a computer using voice and dual-tone multi-frequency signaling (DTMF) tones; for example, to allow users to interact with a host via a telephone keypad or by speech recognition, using an IVR dialogue.

### SUMMARY OF THE INVENTION

Principles of the invention provide techniques for router management; for example, using text messaging and/or IVR. In one aspect, an exemplary method includes the operations of sending, from an accessibility gateway microservice, to a device of a user, a message including a menu of access point management options; obtaining, at the accessibility gateway microservice, from the device of the user, a message including a selection from the menu; at the accessibility gateway microservice, translating the selection from the menu into a command formatted for a connectivity platform services layer; and dispatching, from the accessibility gateway microservice, to the connectivity platform services layer, the command.

In another aspect, a non-transitory computer readable medium includes processor executable instructions which when executed by a processor cause the processor to perform a method comprising: sending, from an accessibility gateway microservice, to a device of a user, a message including a menu of access point management options; obtaining, at the accessibility gateway microservice, from the device of the user, a message including a selection from the menu; at the accessibility gateway microservice, translating the selection from the menu into a command formatted for a connectivity platform services layer; and dispatching, from the accessibility gateway microservice, to the connectivity platform services layer, the command.

In still another aspect, an exemplary system includes an accessibility gateway microservice implemented using at least one accessibility gateway microservice processor, which is operative to: send, to a device of a user, a message including a menu of access point management options; obtain, from the device of the user, a message including a selection from the menu; translate the selection from the menu into a command formatted for a connectivity platform services layer; and dispatch, from the accessibility gateway microservice, to the connectivity platform services layer, the command.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
improving the technological process of operating a broadband network for users in need of additional accessibility options (e.g., those who are visually impaired);
improving the technological process of operating a broadband network for users who do not have access to a “smart” cellular phone but instead use a “dumb” phone.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 is a block diagram of a cloud-based router management system employing text messaging, in accordance with an example embodiment;

FIG. 11 is a sequence diagram of a cloud-based router management process employing text messaging, in accordance with an example embodiment;

FIG. 12 is a block diagram of a cloud-based router management system employing interactive voice response (IVR), in accordance with an example embodiment;

FIG. 13 is a sequence diagram of a cloud-based router management process employing interactive voice response (IVR), in accordance with an example embodiment;

FIG. 14 shows aspects of message/command translation, in accordance with an example embodiment; and

FIG. 15 is a block diagram of a “smart” cellular telephone useful in connection with one or more aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Purely by way of example and not limitation, some embodiments will be shown in the context of a cable multi-service operator (MSO) providing data services (such as acting as an Internet Service Provider (ISP)) as well as entertainment services. However, this is a non-limiting example, and embodiments can be implemented in a variety of contexts where routers are used in networks. The following non-limiting example depicts exemplary CPE 106 in the form of an integrated solution including a cable modem (e.g., DOCSIS) and one or more wireless routers; however, as noted below, other embodiments could employ a two-box solution; i.e., separate cable modem and routers suitably interconnected, which nevertheless, when interconnected, can provide equivalent functionality. The following non-limiting example also depicts other routers including head-end routers 1091, point-of-presence (“POP”) router 1008, regional data center (RDC) routers (RR) 1060 and the like. While exemplary embodiments can be used in connection with any of elements 106, 1091, 1008, 1060, and others, one or more embodiments are believed to be particularly helpful in connection with in-premises routers such as in CPE 106 (integrated or stand-alone) where one or more persons in the premises are visually impaired.

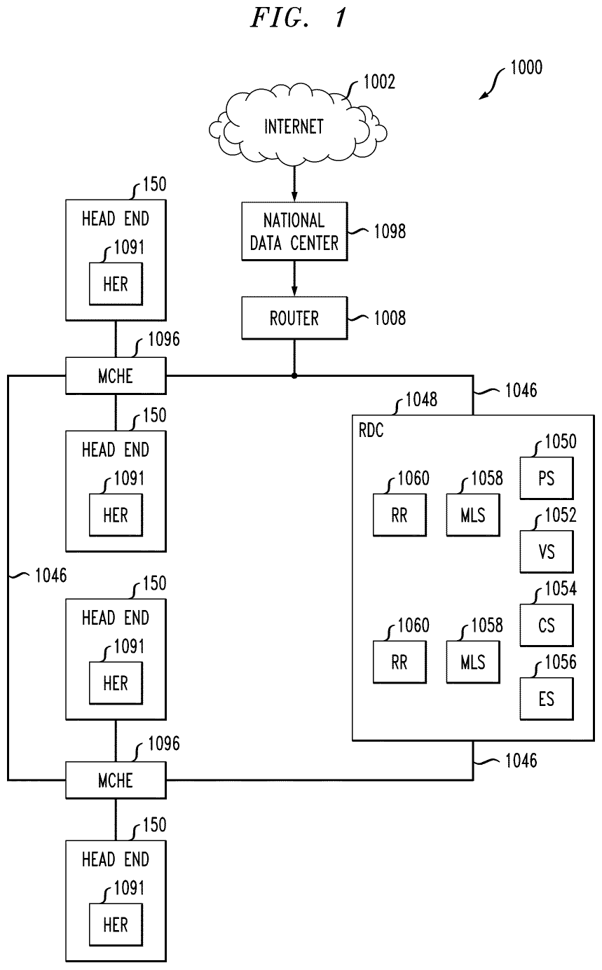

FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

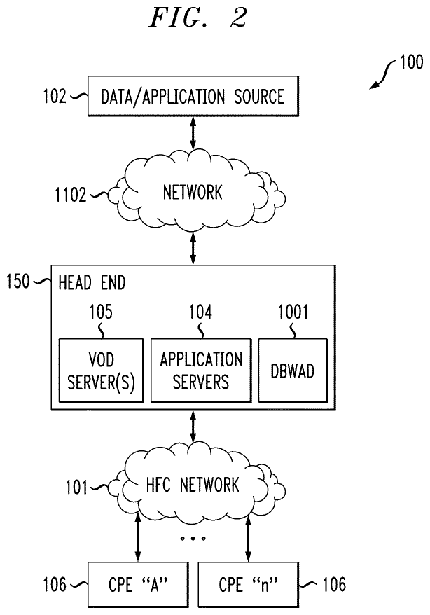

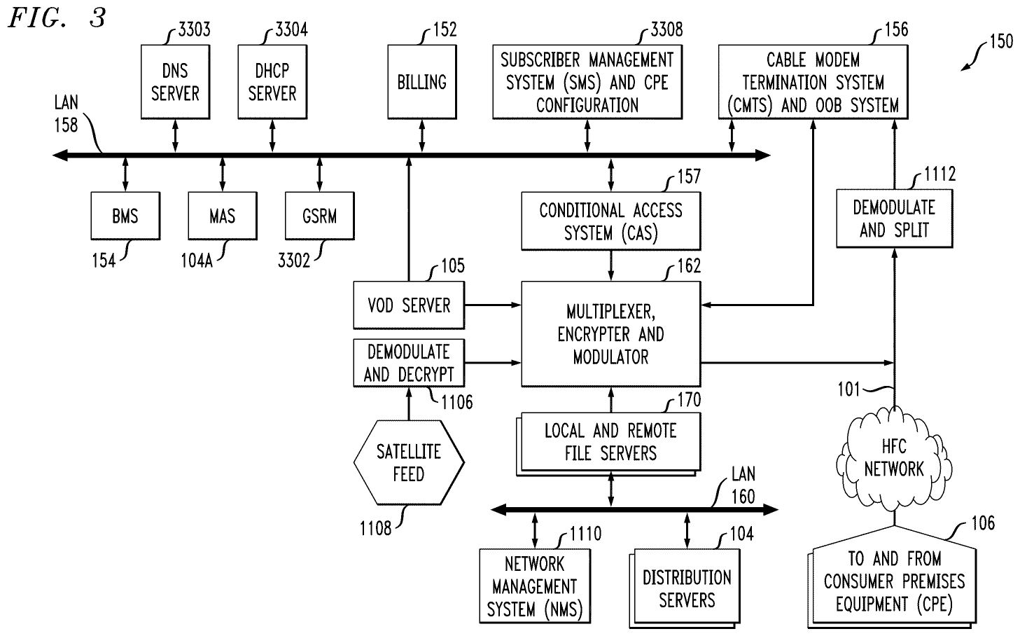

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

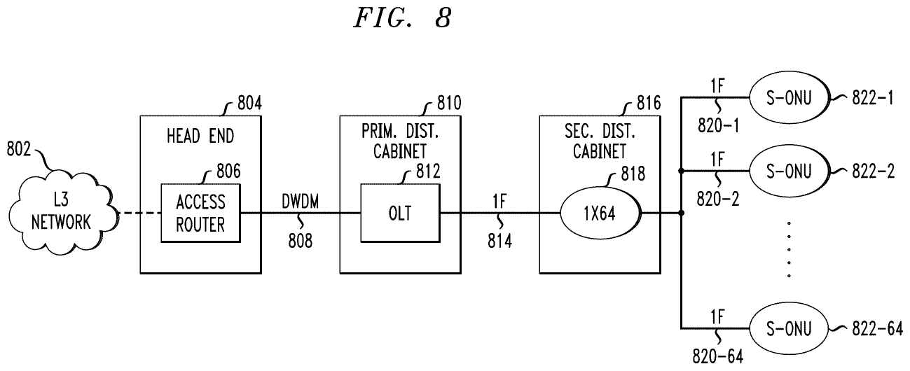

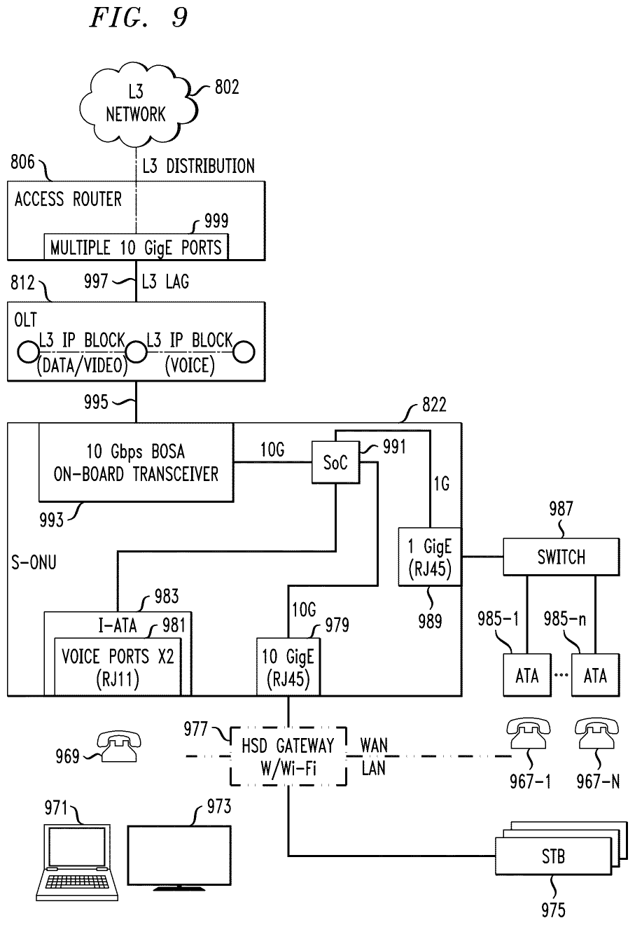

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

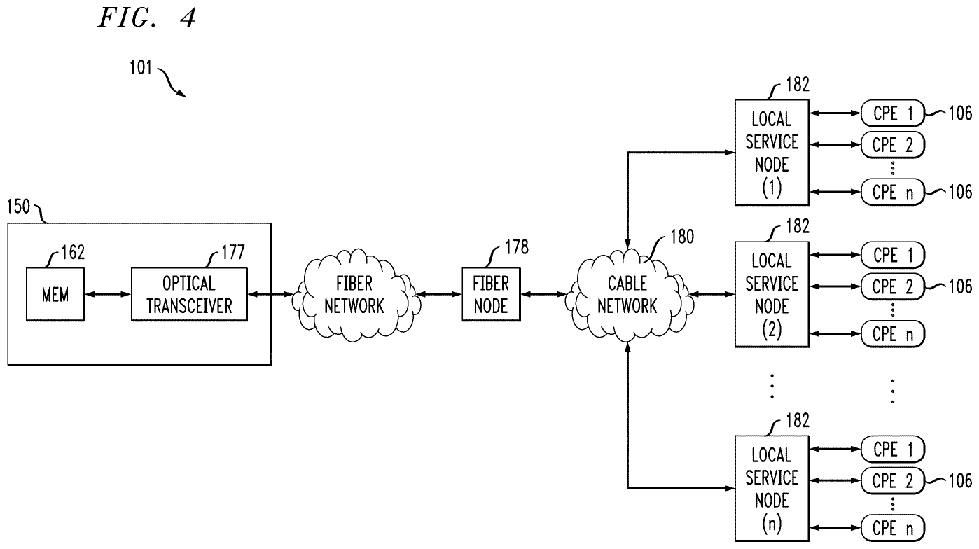

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

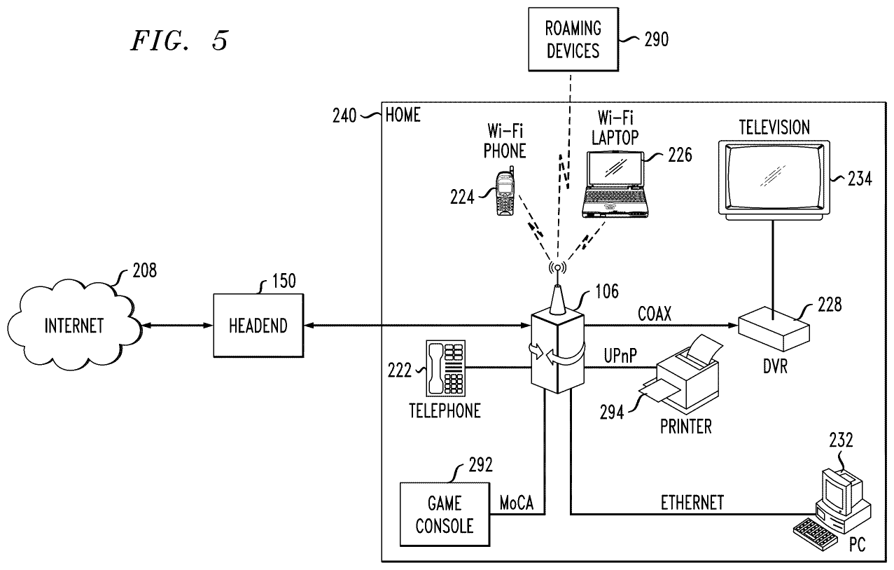

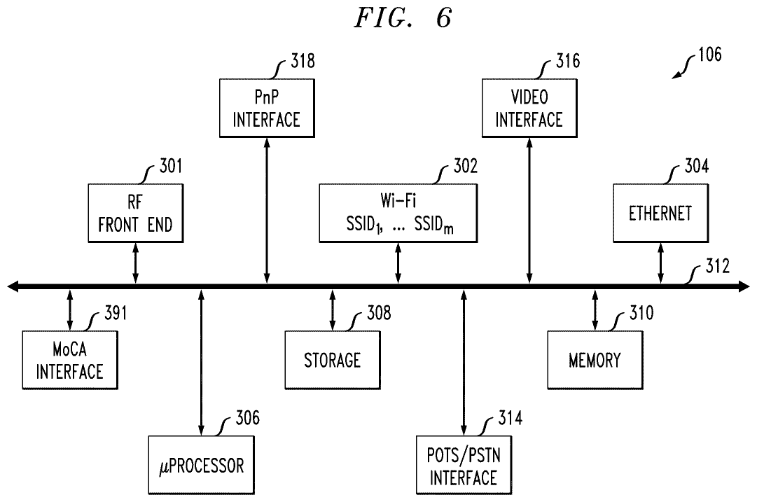

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Again, while the exemplary context of an HFC or FTTC/FTTH has been presented, embodiments are not limited to such a context, and can generally be used in the context of any broadband provider/ISP with routers, especially routers in the premises.

Principles of the present disclosure will be described herein in the context of apparatus, systems, and methods for router management; for example, using text messaging and/or IVR. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred. Furthermore, the routers managed in accordance with aspects of the invention can be stand-alone routers and/or routers incorporated within larger assemblies such as, for example, the gateway device 106 described above with regard to FIGS. 5 and 6.

Generally, techniques for router management are disclosed; in one or more embodiments, such techniques are helpful to the visually impaired. Indeed, for visually impaired customers, managing a router may be a challenging task using current techniques. In order to help such individuals, one or more embodiments provide router management and notifications via text message and/or IVR.

Currently, customers may receive text messages when their routers are offline and/or when their routers come back online. In one or more embodiments, customers securely receive their service set identifiers (SSIDs) and/or passwords via text message or IVR after customer verification via two-factor authentication. Verified customers can also change their SSIDs and passwords on the router via text or IVR.

A variety of other router features can be modified and/or have status updates and/or other actions in accordance with aspects of the invention. By way of example and not limitation, such router and/or modem features include:
Rebooting devices (modem, router, or Wi-Fi extender) and providing notification when reboot is complete
Providing a notification whether a Wi-Fi extender is online/offline
Pause schedules (enabled/disabled/setup/delete) (that is to say, many router manufacturers and/or ISPs offer the user the ability to suspend the internet service from devices that connect to the router. For example, if the user pauses the user's streaming device on the network, that device will stay connected to the router but will not be able to stream content as it will not have access to the internet)
Grouping pause schedules (enabled/disabled/setup/delete) (group pause allows the user to restrict internet access to multiple connected devices (e.g. phone, laptop, streaming service with associated hardware and software) at the same time; the above discussion of pause schedules is relevant to this aspect as well)
Viewing router connection status
Viewing multiple routers and connection status (similar aspect to the above, covering the possibility of having multiple routers on the same account to be managed)
Viewing router information, such as manufacturer and/or model
Viewing connected devices and associated information, such as advanced device identification, nickname, IP address, hostname, media access control (MAC) address, connection type, and the like
Editing Wi-Fi extender name
Renaming Wi-Fi extender reminder (e.g., providing a friendly/more descriptive name to the Wi-Fi extender, such as, e.g., Living Room/Game room/Master bedroom)
Viewing Wi-Fi extender information (model, serial number, etc.)
Guest Network (e.g., allow the users of an advanced Wi-Fi router to create an additional Wi-Fi network with a separate SSID (network name) and password that can be provided to visitors/guests)
Carrying out speed test
Viewing public IPv4/v6 address
Domain Name System (DNS) (e.g., change the address of the DNS server)
Reserving local area network (LAN) IP and port forwarding
Factory Reset Equivalent (i.e., resetting equipment) enabling/disabling Universal Plug and Play (UPnP)
Providing new device connection notification
Providing parental controls
Viewing support articles
Viewing a user guide.

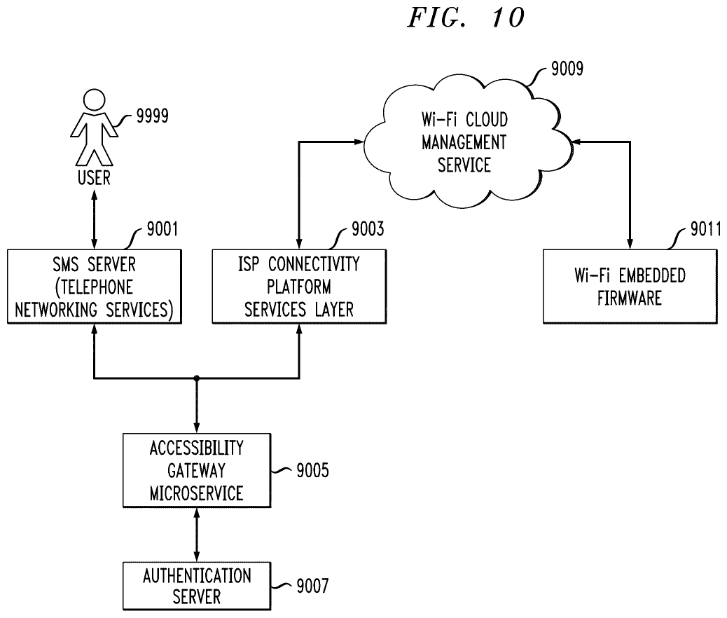

FIG. 10 is a block diagram of a router management system, in accordance with an example embodiment. SMS server 9001 is, for example, an external component that embodiments of the invention network with; i.e., it provides an interface between embodiments of the invention and the customer 9999. In one or more embodiments, it receives SMS or other text messages from customer 9999 and sends SMS or other text messages to customer 9999. The customer can be using, for example, any cellular telephone network, whether operated by the ISP or otherwise. Given the teachings herein, the skilled artisan can adapt known SMS aggregator functionality to implement one or more embodiments.

Accessibility gateway microservice (AGM) 9005 provides an integration point to intake SMS or other text messages and then interface with logic on the back end to carry out functions and services. AGM 9005 also provides a first authentication point and reaches out to authentication server 9007.

In some instances, authentication server 9007 is implemented by adapting a known system. In one or more embodiments, authentication server 9007 verifies that the SMS or other text message is from a user with valid credentials. A user of SMS or other text messaging protocol can communicate with an existing authentication system. Server 9007 can be located, for example, in the ISP's network.

ISP connectivity platform services layer 9003 is a middleware tool to manage Wi-Fi features (the skilled person will be familiar with software for Wi-Fi access points, routers and other broadband consumer premises equipment designed to help customers manage their in-home Wi-Fi networks; a non-limiting example is Spectrum® Connectivity Platform (SCP), available from Charter Communications, Inc., Stamford, CT, USA; registered mark of CHARTER COMMUNICATIONS HOLDING COMPANY, LLC ST. LOUIS MISSOURI USA). Services layer 9003 provides an application programming interface (API) layer that accesses Wi-Fi cloud management service 9009. In one or more exemplary embodiments, services layer 9003 can reside within the ISP's network, or within a cloud service (Amazon Web Service (AWS®) is a non-limiting example, registered mark of Amazon Technologies, Inc. Seattle WASHINGTON USA) under control of the ISP, or partially within the ISP's network and partially within the cloud service. Services layer 9003 provides, for example, a way in which ISP services interact with cloud service 9009 (e.g., cloud products and/or services available from Plume Design, Inc. Palo Alto, CA, USA). That is to say, in one or more embodiments, AGM 9005 does not directly access cloud service 9009, but rather through ISP connectivity platform services layer 9003.

In one or more embodiments, service 9009 is an entity that holds state tables and other needed router management features. These tables can, for example, specify that a certain router for a certain customer should use a certain Wi-Fi SSID and other specific settings. In one or more embodiments, Wi-Fi cloud management service 9009 communicates directly with firmware on the router (i.e., Wi-Fi embedded firmware 9011) to enact changes based on the rightful state determined by service 9009. Wi-Fi cloud management service 9009 can be implemented, for example, in software that is, e.g., prepared by a cloud vendor (e.g., Plume Design, Inc.) and customized by the ISP to manage Wi-Fi features. Wi-Fi cloud management service 9009 allows, for example, a router in a customer's premises (e.g., CPE 106) that typically can only be managed through a customer interface to be managed from outside the home or other premises by uploading and synchronizing settings using cloud service 9009.

Wi-Fi embedded firmware 9011 is a tool to manage Wi-Fi features, and resides on the router of the ISP customer within the customer's premises. The skilled artisan is familiar with router firmware, which in some instances is supplied along with the router when the router is obtained from the vendor/original equipment manufacturer (OEM). Wi-Fi embedded firmware 9011 could also be developed by an ISP or an ISP working with one or more vendors/OEMs. For example, a suitable operating system targeting embedded devices can be employed.

With reference to elements 9003, 9009, 9011, consider a typical mode of interaction—such as a self-service “app” provided for a user's smart phone or the like that allows user to control the user's experience with an ISP such as an MSO that provides broadband and optionally entertainment. The My Spectrum® App available from Charter Communications, Inc., Stamford, CT, USA is a non-limiting example. Using such an “app,” a customer can change, e.g., Wi-Fi SSID and password. In one or more embodiments, the AGM 9005 creates a new channel to manage the Wi-Fi router.

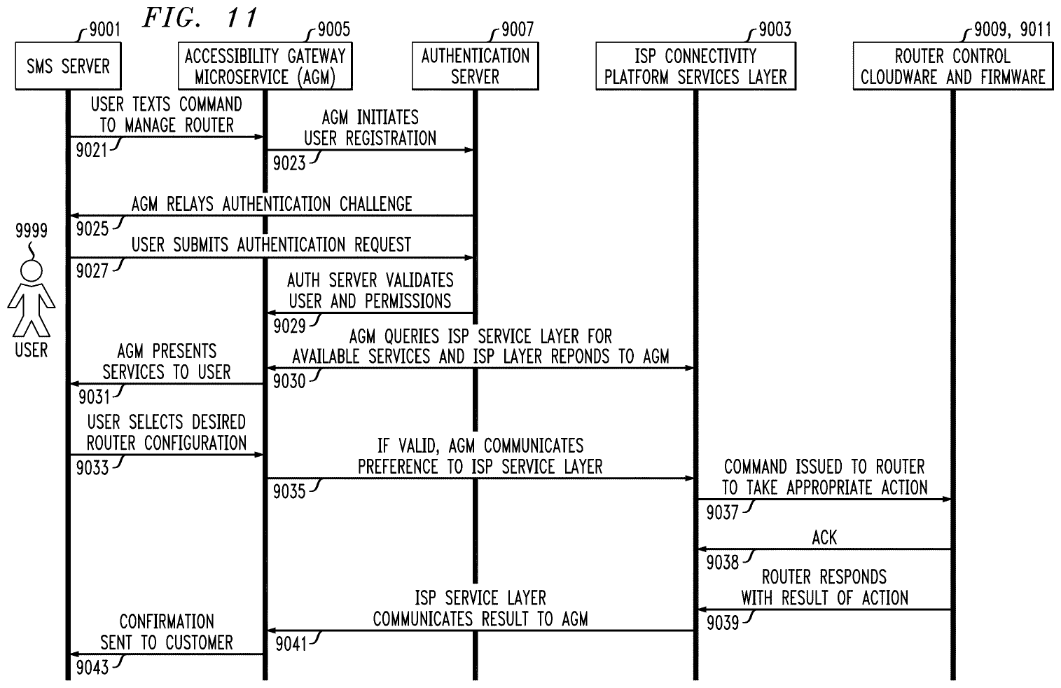

Referring now to FIG. 11, consider an exemplary use case where a customer/user 9999 seeks to change the name of the user's Wi-Fi network. The customer is given a number to text to manage the router. The user texts the number in step 9021. The text message arrives at AGM 9005. In step 9023, AGM 9005 initiates registration with the authentication server 9007, advising the authentication server 9007 that a text was received from a certain number. Note arrow 9025 where the AGM 9005 relays an authentication challenge from server 9007 to the user 9999. In step 9027, user 9999 submits an authentication request to server 9007—e.g., a password. Referring to step 9029, authentication server 9007 checks the password and user information and determines whether the user has valid permissions and what services the user has subscribed to. Double-headed arrow 9030 from 9003 to 9005 indicates that AGM 9005 queries layer 9003 for all the available services for that router, and the response comes back. In the case of Wi-Fi management, the user will be a subscriber of Wi-Fi services, for example. In step 9031, the AGM 9005 then tells the user what things the user can do—for example, 1=Manage X, 2=Manage Y, 3=Manage Z, . . . (based on the response that came back as discussed with regard to 9030).

In step 9033, the user 9999 selects the desired router configuration option; here, to change the user's Wi-Fi network name. If the user's selection of the desired router configuration is valid, the AGM 9005 communicates the user's preferences to the service layer 9003 in step 9035. AGM 9005 provides abstraction and translation so that the user 9999 is presented choices to implement commands via text and then AGM 9005 translates the commands received from the user so that they can be understood down the line by server 9007 and services layer 9003. Once services layer 9003 obtains the appropriate information, it carries out the same steps as in a current system; namely, a command is issued to router 9009, 9011 at step 9037 to take appropriate action, and router 9009, 9011 responds in step 9039 with a result of the action. Note also the acknowledgement “ACK” 9038 which acknowledges the command—this is useful as there may be some scenarios where the command may be received but the service 9009/9011 may not be able to perform the action for whatever reason. In step 9041, the router response is passed back to the AGM 9005 which confirms to the customer in step 9043.

In one or more embodiments, AGM 9005 obtains a text message and translates it so that the platform services layer 9003 can understand it and turn it into a command for the router. In step 9031, the AGM 9005 tells the user 9999 what options/commands he or she can implement, based on the permissions obtained at 9029. In one or more embodiments, the AGM 9005 uses text messaging to tell the user 9999 what options/commands he or she can implement; however, the texts can be formatted in a manner similar to an IVR menu. In one or more embodiments, the AGM 9005 maps out the options for the user—for example, 1=Manage X, 2=Manage Y, 3=Manage Z, . . . . Furthermore, in one or more embodiments, the AGM 9005 gets responses back from the telephony network and maps them to commands that can be understood by services layer 9003. Further regarding the AGM 9005 mapping out the options for the user, additional examples include Text 1 to change name, Text 2 to reboot, . . . . It is worth noting that firmware 9011 may permit, for example, fifty remote actions to be taken on the router while the system may select, for example, the ten most important or more commonly used remote actions to be implemented by the text-based system.

Consider again step 9033, “User selects desired router configuration.” For example, AGM 9005 receives a text of a number from 0 to 9—for example, a “3.” AGM 9005 has a translation table; AGM 9005 looks up a “3” in the table and determines that “3” means change the name by which the router is called, or reboot the router, or some other command. Thus, the translation table in the AGM 9005 translates “3” into a command that can be understood by the services layer 9003. That command is sent from the AGM to the services layer in step 9035 together with arguments/metadata specifying the customer, target account number, authentication, target router identification, and the like.

In one or more embodiments, after the initial authentication (e.g., the customer texts the ISP attempting to change network name and password, AGM 9005 issues/relays a challenge-say, tell the user to enter the user's password, then send the user a text and the user must verify the text (e.g., 6-digit security code). This increases confidence that it is the actual user and that the user is accessing the system from a device in the user's possession. The information provided by the user is enough to authenticate the user and the user's device. After that, a security token could be issued to the user (and optionally provided to layer 9003), in lieu of constantly asking for the user's password, so that it will be determined that the command passed by the AGM comes from an authenticated user in good standing and not some unknown malicious actor or a customer whose services may not be active.

The services layer 9003 can carry out further translation and/or modification of the command by abstracting the commands sent to the cloud 9009 so that the ISP's internal applications do not have to be concerned with compatibility when there has been a change in the commands from the cloud or the like. The services layer 9003 can act as an abstraction layer/buffer between the ISP's user interface (UI) and/or applications and the cloud layer 9009. Typically, the services layer 9003 can be thought of as a middleware layer (the skilled artisan is familiar with the general concept of a middleware layer). In addition to authentication, authorization can also be carried out as appropriate to verify that the authenticated user has authority to undertake the requested action (for example, perform a check in a subscriber database to determine that the requested action is valid for that user).

Further regarding the concept of a middleware layer, suppose a company subscribes to a gaming service, and the gaming service does not want to provide a direct connection to company employees in their homes. The employee may be required to go through an authentication gateway that resides within the company. That authentication server 9007 or middleware layer will, in effect, indicate that any request seen coming from the authentication layer to the gaming server should be recognized because the authentication layer will verify the person sending the commands and so on. This will, in effect, appear like one service, talking to the cloud, which is pre-authenticated and can batch commands together to implement services. For example, in the case of multiple commands that come from the same user or a command that may involve multiple steps, the system could group the commands together for efficient processing and send along one set of authentication credentials (as opposed to adding authentication instructions to each individual command). The layer 9003 obtains communications from the AGM 9005 and provides information back to the AGM 9005 in a certain way, ensuring that the command provided from the AGM 9005 is correctly reformatted when sent to the cloud 9009, and vice versa. The AGM 9005 interfaces with the client texts and translates the texts into commands that can be understood by the existing system (e.g., layer 9003) to control the router configuration.

Continuing to refer to FIG. 11, in one or more embodiments, in step 9021, User/Customer 9999 texts a predetermined accessibility number with a help request. This text command is directed to AGM 9005. If this is the customer's first time accessing the system, AGM 9005 sends user 9999 a sign-up message with a link to opt in to the service; assuming the customer opts in, the AGM initiates registration at 9023 after which the user is authenticated as discussed with regard to steps 9025-9029. Also, after the user opts in, the ISP flags the customer's account, the device the user is texting from (e.g., “smart” cell phone), and optionally the router(s) associated with the account, for accessibility service.

Given the teachings herein, the skilled artisan will be able to adapt known authentication techniques, such as two-factor authentication techniques, to verify customers in one or more embodiments.

In one or more embodiments, the ISP connectivity platform services layer 9003 communicates with the router via the service 9009 (for example, using OpenSync® cloud software (registered mark of Plume Design, Inc. Palo Alto CALIFORNIA USA), although techniques used for retrieving information from the router can vary) and retrieves available options see discussion of line 9030 above. The response may be cached by the AGM. The AGM receives this information from the layer 9003.

In step 9031, the customer 9999 is presented with options to review or adjust certain settings on the router via text messages. In step 9033, the customer uses text responses to navigate the options and make changes if necessary. In step 9035, if the user has made a valid selection, the AGM 9005 passes the preference to the ISP Connectivity Platform Services Layer 9003, which communicates with the router via the service 9009 and retrieves and writes the selected configuration, as shown at 9037. The changes are confirmed via messages; note the ACK 9038, router response at 9039, the communication at 9041, and the confirmation 9043.

In some cases, an option is presented to the user 9999 to schedule a pre-authenticated callback if additional help is needed.

It is worth noting that in one or more text-based embodiments, user 9999 sends text messages to, and receives text messages from, SMS server 9001 using known mobile telephony texting techniques; further, as noted elsewhere, formats other than SMS can be used and server 9001 can be thought of generally as a texting server not limited to the SMS format. Non-limiting examples of other formats include iMessage® messages (registered mark of Apple Inc. Cupertino CALIFORNIA USA), Rich Communication Services (RCS) messages, and the like.

Note that in one or more non-limiting exemplary embodiments, embedded firmware 9011 resides on a router such as within element 106; cloud management service 9009 resides in Internet cloud 1002; auth server 9007 could reside in block 3308 in FIG. 3 for authentication and authorization; and AGM 9005 and layer 9003 can be cloud-based (e.g., within 1002), interfacing with external SMS server 9001 (or external IVR Server 9001A discussed below).

It is worth noting that one or more embodiments (text and/or IVR based) advantageously enable any action that has a known command within 9009 to be remotely implemented using translation because we just translate in AGM 9005.

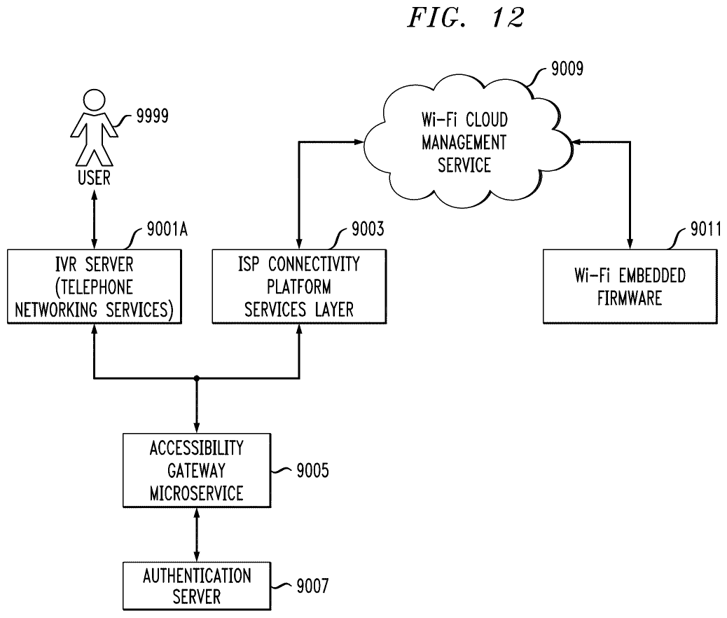

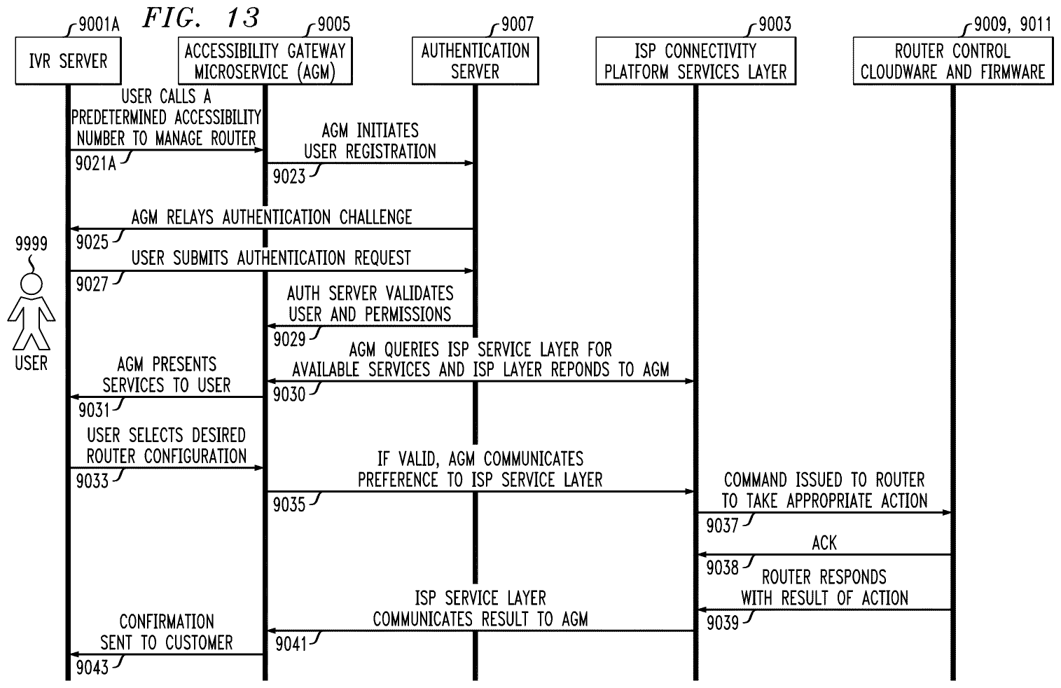

In addition to text message-based approaches, other approaches can be employed in other embodiments; for example, an IVR-based approach. In this aspect, refer to FIGS. 12 and 13 which are similar to FIGS. 10 and 11, respectively, except that SMS server 9001 is replaced by IVR server 9001A; communications with User 9999 are voice/telephone keypad communications using IVR, as opposed to text as in the earlier embodiment. As the skilled artisan will appreciate, IVR systems make use of voice prompts, with responses via speech or telephone keypad. In step 9021A, the customer 9999 calls a predetermined accessibility number rather than texting it.

The description of the system of FIG. 12 is similar to that of FIG. 10 except for the substitution of the IVR server 9001A for the SMS server 9001. IVR server 9001A is, for example, an external component that embodiments of the invention network with; i.e., it provides an interface between embodiments of the invention and the customer 9999. In one or more embodiments, it receives voice or telephone keypad input from customer 9999 and provides voice prompts to customer 9999. The customer can be using, for example, any suitable telephone network, whether operated by the ISP or otherwise. Given the teachings herein, the skilled artisan can adapt known IVR functionality to implement one or more embodiments.

Thus, operations in FIG. 13 are similar to those in FIG. 11 except that communications with the user 9999, such as at 9025, 9031, and 9043 are by voice prompt; and input from the user 9999, such as at 9021, 9027, 9033 are by voice or telephone keypad. For confirmation 9043, e.g., a synthesized voice indicates that the change is confirmed.

Here as well, in some cases, an option is presented to the user 9999 to schedule a pre-authenticated callback if additional help is needed.

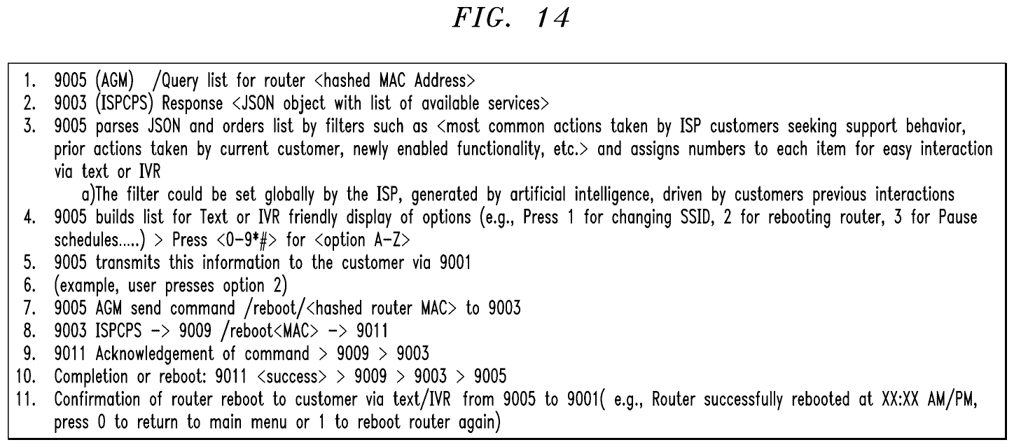

Command translation: Refer now to FIG. 14 for exemplary aspects of command translation applicable to text and IVR aspects of the invention. Translation can be performed by the AGM 9005, for example. In line 1, corresponding to the first part of operation 9030, the AGM 9005 queries the layer 9003 based on the hashed MAC address of the router. In line 2, corresponding to the second part of operation 9030, layer 9003 responds, for example, with a JSON (JavaScript Object Notation) object with a list of available services. In line 3, the AGM parses the JSON and uses filters to order the list. Example filters include <most common actions taken by ISP customers seeking support behavior, prior actions taken by current customer, newly enabled functionality, etc.>. Numbers are assigned to each item for easy interaction via text or IVR. The filter could be set globally by the ISP, generated by artificial intelligence, driven by customers previous interactions.

In line 9, the AGM builds a list, based on the filtering, permitting display of options via text or ISR. Non-limiting examples include Press 1 for changing SSID, 2 for rebooting router, 3 for Pause schedules; generally, > Press <0-9*#> for <option A-Z> (or the equivalent Say 1, Say 2, . . . ). Line 5 corresponds to operation 9031. Line 6 corresponds to an example of operation 9033. Line 7 corresponds to an example of operation 9035. Line 8 corresponds to an example of operation 9037. Line 9 corresponds to ACK operation 9038. Line 10 reflects completion of the reboot including aspects of operations 9039, 9041. Line 11 refers to operation 9043.

So, for example, in operation 9031 send the user a text message “text 1 to change name of your router, text 2 to reboot your router, . . . ” and receive back from the user menu option 9. AGM 9005 translates menu option 9 into something understandable by layer 9003. One or more embodiments use PERL or another scripting language and a suitable translation table.

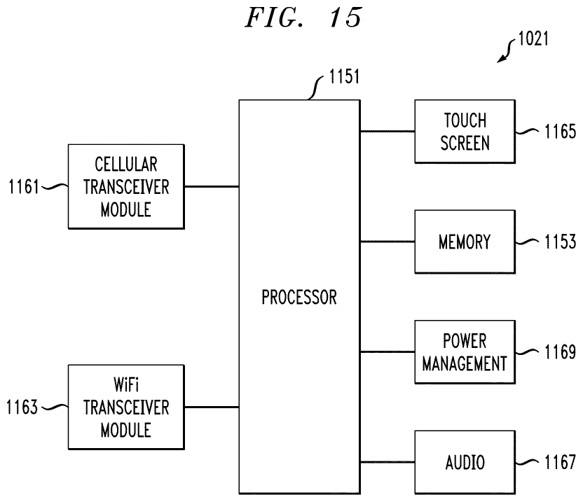

FIG. 15 shows an exemplary configuration of a mobile device 1021 such as a mobile phone, cellular-enabled tablet, or cellular-enabled laptop. Device 1021 includes a suitable processor; e.g., a microprocessor 1151. Device 1021 can be used to send and receive text messages in text embodiments and is a non-limiting example of a telephone that can access an IVR system in IVR embodiments. A cellular transceiver module 1161 coupled to processor 1151 includes an antenna and appropriate circuitry to send and receive cellular telephone signals, e.g., 3G, 4G, or 5G. A Wi-Fi transceiver module 1163 coupled to processor 1151 includes an antenna and appropriate circuitry to allow phone 1021 to connect to the Internet via a wireless network access point or hotspot.

In one or more embodiments, one or more applications (“apps”) in memory 1153, when loaded into RAM or other memory accessible to the processor cause the processor 1151 to implement aspects of the functionality described herein. Functionality can also be provided via a browser.

Touch screen 1165 coupled to processor 1151 is also generally indicative of a variety of I/O devices, all of which may or may not be present in one or more embodiments. Memory 1153 is coupled to processor 1151. Audio module 1167 coupled to processor 1151 includes, for example, an audio coder/decoder (codec), speaker, headphone jack, microphone, and so on. Power management system 1169 can include a battery charger, an interface to a battery, and so on.

Given the discussion thus far, it will be appreciated that, in general terms, an exemplary method, according to an aspect of the invention, includes the step 9031 of sending, from an accessibility gateway microservice (AGM) 9005, to a device of a user 9999, a message (text or IVR) including a menu of access point management options. In this context, the device of the user 9999 refers to the user's phone for IVR or the user's smart phone/tablet/laptop/desktop for the text-based option. Further steps include, at 9033, obtaining, at the accessibility gateway microservice, from the device of the user, a message including a selection from the menu; at the accessibility gateway microservice, translating (see discussion elsewhere herein) the selection from the menu into a command formatted for a connectivity platform services layer 9003; and, at 9035, dispatching, from the accessibility gateway microservice, to the connectivity platform services layer, the command.

Note that the term access point includes a router (stand alone or part of a larger assembly such as 106) and/or a Wi-Fi extender.

One or more embodiments further include, as at 9041, obtaining, at the accessibility gateway microservice, from the connectivity platform services layer, a message including a result of an action taken by access point firmware in response to the command; at the accessibility gateway microservice, translating the message into a confirmation text message (see discussion elsewhere herein); and, as at 9043, sending, from the accessibility gateway microservice, to the device of the user, the confirmation text message.

Some embodiments further include, as at 9035, obtaining, at the connectivity platform services layer, the command; and, as at 9037, the connectivity platform services layer causing the access point firmware to implement the command. An optional further step includes the connectivity platform services layer reformatting the command prior to causing the access point firmware to implement the command (e.g., to translate it into a form understandable by the cloudware). In some instances, layer 9003 updates a table on the access point. Layer 9003 could modify the command, for example, by adding information about the source. Commands within the ISP's network could be in a simplified form, for example.

Some embodiments further include, as at 9039, obtaining, at the connectivity platform services layer, a message from the router firmware including the result of the action; and, optionally, at the connectivity platform services layer, reformatting the message from the router firmware to render the message understandable by the accessibility gateway microservice. In this aspect, for example, in the step of obtaining, at the accessibility gateway microservice, from the connectivity platform services layer, the message including the result of the action taken by the router firmware in response to the command, the message including the result of the action taken by the router firmware that is obtained at the accessibility gateway microservice comprises the reformatted message rendered understandable by the accessibility gateway microservice. See operation 9041.

Some instances further include obtaining, at the accessibility gateway microservice, from an authentication server 9007, a message including validation of the device of the user. In this aspect, the step of sending, from the accessibility gateway microservice, to the device of the user, the message including the menu of router management options, is performed responsive to the obtaining, at the accessibility gateway microservice, from the authentication server, the message including the validation of the device of the user; i.e., operation 9031 is responsive to operation 9029.

Some instances further include the accessibility gateway microservice facilitating registration of the device of the user prior to obtaining the message including validation of the device of the user from the authentication server. Refer to operations 9021-9027 and 9021A-9027. In this aspect, to set up text or IVR management of the user's access device, the user is advised to text “123abc” or other predetermined alphanumeric string to a certain number or to call a certain number in the IVR case. When the AGM receives the text or call, it initiates the registration process by adapting known techniques.

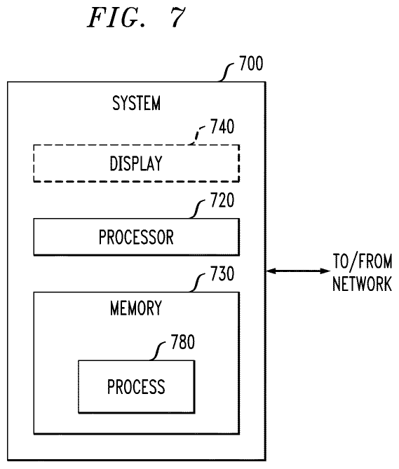

In another aspect, an exemplary system includes any one, some, or all of the elements depicted in FIGS. 10-13 (although the servers 9001, 9001A are typically external to the system in many cases). For example, the system can include an accessibility gateway microservice implemented using at least one accessibility gateway microservice processor operative to facilitate or otherwise carry out any one, some, or all of the method steps described herein as being done by microservice 9005. In some cases, for example, the system further includes the connectivity platform services layer 9003 implemented using at least one connectivity platform services layer processor operative to carry out any one, some, or all of the method steps described herein as being done by the connectivity platform services layer 9003. See discussion of FIG. 7, for example.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 15). The memory 1530 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
sending, from an accessibility gateway microservice, to a device of a user, a message including a menu of access point management options;
obtaining, at the accessibility gateway microservice, from the device of the user, a message including a selection from the menu;
at the accessibility gateway microservice, translating the selection from the menu into a command formatted for a connectivity platform services layer; and
dispatching, from the accessibility gateway microservice, to the connectivity platform services layer, the command.

2. The method of claim 1, further comprising:
obtaining, at the accessibility gateway microservice, from the connectivity platform services layer, a message including a result of an action taken by access point firmware in response to the command;
at the accessibility gateway microservice, translating the message into a confirmation message; and
sending, from the accessibility gateway microservice, to the device of a user, the confirmation message.

3. The method of claim 2, further comprising:
obtaining, at the connectivity platform services layer, the command; and
the connectivity platform services layer causing the access point firmware to implement the command.

4. The method of claim 3, further comprising the connectivity platform services layer reformatting the command prior to causing the access point firmware to implement the command.

5. The method of claim 3, further comprising:
obtaining, at the connectivity platform services layer, a message from the router firmware including the result of the action; and
at the connectivity platform services layer, reformatting the message from the router firmware to render the message understandable by the accessibility gateway microservice;
wherein, in the step of obtaining, at the accessibility gateway microservice, from the connectivity platform services layer, the message including the result of the action taken by the router firmware in response to the command, the message including the result of the action taken by the router firmware that is obtained at the accessibility gateway microservice comprises the reformatted message rendered understandable by the accessibility gateway microservice.

6. The method of claim 2, further comprising obtaining, at the accessibility gateway microservice, from an authentication server, a message including validation of the device of the user, wherein the step of sending, from the accessibility gateway microservice, to the device of the user, the message including the menu of router management options is performed responsive to the obtaining, at the accessibility gateway microservice, from the authentication server, the message including the validation of the device of the user.

7. The method of claim 6, further comprising the accessibility gateway microservice facilitating registration of the device of the user prior to obtaining the message including validation of the device of the user from the authentication server.

8. The method of claim 1, wherein the message including the menu of access point management options and the message including the selection from the menu comprise text messages.

9. The method of claim 1, wherein the message including the menu of access point management options and the message including the selection from the menu comprise interactive voice response messages.

10. The method of claim 1, wherein the menu of access point management options comprises a menu of router management options.

11. A non-transitory computer readable medium comprising processor executable instructions which when executed by a processor cause the processor to perform a method comprising:
sending, from an accessibility gateway microservice, to a device of a user, a message including a menu of access point management options;
obtaining, at the accessibility gateway microservice, from the device of the user, a message including a selection from the menu;
at the accessibility gateway microservice, translating the selection from the menu into a command formatted for a connectivity platform services layer; and
dispatching, from the accessibility gateway microservice, to the connectivity platform services layer, the command.

12. A system comprising:
an accessibility gateway microservice implemented using at least one accessibility gateway microservice processor operative to:
send, to a device of a user, a message including a menu of access point management options;
obtain, from the device of the user, a message including a selection from the menu;
translate the selection from the menu into a command formatted for a connectivity platform services layer; and
dispatch, from the accessibility gateway microservice, to the connectivity platform services layer, the command.

13. The system of claim 12, wherein the at least one accessibility gateway microservice processor is further operative to:
obtain, from the connectivity platform services layer, a message including a result of an action taken by access point firmware in response to the command;
translate the message into a confirmation message; and
send, from the accessibility gateway microservice, to the device of the user, the confirmation message.

14. The system of claim 13, wherein the at least one accessibility gateway microservice processor is further operative to:
obtain the command; and
cause the access point firmware to implement the command.

15. The system of claim 14, further comprising the connectivity platform services layer, the connectivity platform services layer being implemented using at least one connectivity platform services layer processor operative to reformat the command prior to causing the access point firmware to implement the command.

16. The system of claim 14, wherein the at least one accessibility gateway microservice processor is further operative to:
obtain a message from the router firmware including the result of the action; and
reformat the message from the router firmware to render the message understandable by the accessibility gateway microservice;
wherein, in the obtaining, at the accessibility gateway microservice, from the connectivity platform services layer, the message including the result of the action taken by the router firmware in response to the command, the message including the result of the action taken by the router firmware that is obtained at the accessibility gateway microservice comprises the reformatted message rendered understandable by the accessibility gateway microservice.

17. The system of claim 13, wherein the at least one accessibility gateway microservice processor is further operative to obtain, from an authentication server, a message including validation of the device of the user, wherein the sending, from the accessibility gateway microservice, to the device of the user, the message including the menu of router management options is performed responsive to the obtaining, at the accessibility gateway microservice, from the authentication server, the message including the validation of the device of the user.

18. The system of claim 17, wherein the at least one accessibility gateway microservice processor is further operative to facilitate registration of the device of the user prior to obtaining the message including validation of the device of the user from the authentication server.

19. The system of claim 12, wherein the message including the menu of access point management options and the message including the selection from the menu comprise text messages.

20. The system of claim 12, wherein the message including the menu of access point management options and the message including the selection from the menu comprise interactive voice response messages.

21. The system of claim 12, wherein the menu of access point management options comprises a menu of router management options.
